(19) United States
(12) Patent Application Publication
(10) Pub. No.: US 2010/0187196 A1
(43) Pub. Date: Jul. 29, 2010

(54) Bottle cap cover and removal apparatus

(76) Inventor: Brandy Wasenda, Oldsmar, FL (US)

Correspondence Address: Massinger Law Offices, 887 NE 100th St, Ocala, FL, 34479, US

(21) Appl. No.: 12/655,650

(22) Filed: Jan. 5, 2010

Related U.S. Application Data
(60) Provisional application No. 61/204,410, filed on Jan. 5, 2009.

(51) Int. Cl. B65D 55/00; B67B 7/00

(52) U.S. Cl. 215/386; 81/3.15

(57) ABSTRACT

A cover for caps of the plastic threaded variety typically associated with beverage bottles, the apparatus being comprised of two primary components, namely 1) a hollowed body sized and shaped for the receipt of promotional or advertising indicia or other visually distinctive personalizing indicia on its exterior surface and adapted for frictional engagement with a bottle cap, and 2) optional three-dimensional personalization means integrally formed with or mounted to the top of said hollowed body. By means of this construction is provided a combination bottle identification apparatus and bottle cap removal apparatus which may be used in conjunction with an ordinary beverage bottle equipped with a threaded cap for purposes of facilitating removal of the cap from the bottle, 2) personalizing the bottle so as to avoid the unintended consumption of its contents by another, and 3) serving as a media upon which organizations may impart various promotional and advertising indicia.

### CROSS-REFERENCE TO RELATED APPLICATION

This application claims the benefit of U.S. Provisional Application No. 61/204,410, filed Jan. 5, 2009 and entitled, Bottle Cap Cover and Removal Apparatus.

### FIELD OF THE INVENTION

The present invention relates generally to a bottle cap accessory apparatus and more specifically to a decorative cap cover for mounting to a plastic threaded beverage bottle cap as a means for 1) facilitating removal of the cap from the bottle, 2) personalizing the bottle so as to avoid the unintended consumption of its contents by another, and 3) serving as a media upon which organizations may impart various promotional and advertising indicia.

### BACKGROUND OF THE INVENTION

Bottles having plastic threaded caps are widely used for various beverages including water, juices, teas, soft drinks and the like. A first frequently encountered problem associated with bottled beverages is that the cap can often be difficult to remove without resorting to the use of a cloth or one's own clothing to get a better grip. Several devices have been created to facilitate the removal of caps from the bottle, however, none of these devices also resolve a second problem, namely the unintended consumption of the bottle's contents by a person who mistakes the bottle as their own.

Often the contents of a bottle are consumed directly from the bottle itself as opposed to pouring the contents into a separate drinking vessel such as a glass or cup. Bottled beverages are consumed in a variety of different settings including social gatherings and public places where the bottle may be temporarily rested on a table or bar making it possible for a second party to mistake the bottle for their own, thus resulting in two people drinking from the same container. This may have deleterious consequences including the transmission of germs through shared saliva.

There has been a longstanding need for a single apparatus designed to obviate both of the above described problems. The subject invention offers individuals or organizations a personalized bottle identifier for plastic bottles of all types. It acts as an advertising fixture as well as a product that personalizes and shows ownership of a bottle.

Existing related technology includes decorative corks for wine bottles, flat fiberboard cap covers used to expand surface area for advertising and informational purposes on individually packaged retail products, and replacement bottle caps.

The following additional U.S. patents and applications relating to equine training aids and the like are incorporated herein by reference:

| | | | |
|---|---|---|---|
| 1,593,947 | July 1926 | Miller et al | Jar Wrench |
| D184,726 | March 1959 | Gill | Jar and Bottle Opener |
| 3,730,025 | May 1973 | Monnerhahn | Gripper for Unscrewing Caps |
| 3,812,741 | May 1974 | Heine | Bottle Cap Remover |
| 4,681,358 | July 1987 | Smith | Container Opening Technology |
| 4,759,139 | July 1988 | Ricks | Baby Bottle Identification Skirt |
| 5,301,802 | April 1984 | Nemerof | Individual Drinking Cups |
| 5,358,770 | October 1994 | Evans | Device for Releasably Identifying Objects |
| 5,492,077 | February 1996 | Rose | Indicating Pop Top Beverage Container |
| 5,704,144 | January 1998 | Groth | Beverage Container Identification Tag |
| 5,799,815 | September 1998 | Lang | Device and Kit for Identifying Pop Top Cans |
| 6,745,505 | June 2004 | Moran | Color Coded Beverage Cap |
| | | | Collection with Permanent |
| | | | Passive Indicia Indicating |
| | | | Beverage Bottle User Identities |
| 6,834,763 | December 2004 | Shrader | Personal Identification for Improved Hygiene |
| D452,802 | January 2002 | Peabody | Tool for Threaded Cap |
| D581,229 | November 2008 | Uglum | Novelty Bottle Cap Remover |

None of the existing technology offers a decorative, personalized, reusable, cap cover that facilitates removal of the cap from the bottle, personalizes the bottle so as to avoid the unintended consumption of its contents by another, and serves as a media upon which organizations may impart various promotional and advertising indicia.

All patents, patent applications, provisional applications, and publications referred to or cited herein, or from which a claim for benefit of priority has been made, are incorporated herein by reference in their entirety to the extent they are not inconsistent with the explicit teachings of this specification.

### SUMMARY OF THE INVENTION

In order to meet the need in the art, the subject bottle cap cover and removal apparatus has been created. At least one preferred embodiment of the invention is discussed below.

According to the present invention there is provided a cover for caps of the plastic threaded variety typically associated with beverage bottles, the apparatus being comprised of two primary components, namely 1) a hollowed body sized and shaped for the receipt of promotional or advertising indicia or other visually distinctive personalizing indicia on its exterior surface and adapted for frictional engagement with a bottle cap, and 2) optional three-dimensional personalization means integrally formed with or mounted to the top of said hollowed body. By means of this construction is provided a combination bottle identification apparatus and bottle cap removal apparatus which may be used in conjunction with an ordinary beverage bottle equipped with a threaded cap for purposes of facilitating removal of the cap from the bottle, 2) personalizing the bottle so as to avoid the unintended consumption of its contents by another, and 3) serving as a media upon which organizations may impart various promotional and advertising indicia.

More specifically, the subject invention relates to a cover and removal apparatus for bottle caps of the plastic threaded variety, the apparatus being comprised of an elastically deformable hollowed body having a closed top, an open bottom and a cylindrical side wall therebetween; said top, bottom and side wall defining a chamber; said chamber having a cap engaging portion proximate said top and a skirt portion below said cap engaging portion; said cap engaging portion being sized and shaped to receive the bottle cap therein; said cap engaging portion including a plurality of incrementally spaced cap engaging members extending radially from said side wall into said chamber and longitudinally from said top a distance down said side wall in tapered fashion for frictional engagement with the bottle cap; whereby said hollowed body has a smooth exterior surface for receipt of promotional or other visually distinctive personalizing indicia thereon and three-dimensional personalization means are optionally integrally formed with or mounted to the top of said hollowed body.

There has thus been outlined, rather broadly, the more important components and features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is, therefore, a primary object of the subject invention to provide a bottle cap cover capable of facilitating the removal of the cap from the bottle by providing an ergonomically advantageous shape, soft resilient materials of construction to protect the user's hands and fingers during twisting of the cap, and increased surface area for a better grip and added leverage.

It is another primary object of the subject invention to provide a bottle cap cover available in a plurality of different colors, textures, designs and with other visibly distinctive characteristics and/or components such that the bottle with which the cap is associated is personalized to avoid the unintended consumption of its contents by another.

It is another primary object of the subject invention to provide a bottle cap cover shaped and sized to serve as a substrate upon which an organization may display promotional and advertising indicia.

Another object of the subject invention is to provide a bottle cap cover that facilitates the rapid identification of the user's bottle with which the cap and cover are associated.

Still another object of the subject invention is to provide a means for preventing the spread of germs transmitted through the unintentional sharing of a drinking bottle.

Yet another object of the subject invention is to provide a bottle cap cover that is designed to receive bottle caps of varying sizes.

It is also an object of the subject invention to provide a bottle cap cover that is comprised of relatively few components to facilitate easy assembly and use as well as reduce the chances of mechanical failure.

Another object of the subject invention is to provide a bottle cap cover which is relatively simple in design and therefore capable of rapid construction at relatively low costs.

For a better understanding of the invention, its advantages and the specific objects attained by its uses, reference should be had to the accompanying drawings and descriptive matter in which there is illustrated a preferred embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front elevational view of the bottle cap cover of the present invention;

FIG. 2 is a bottom plan view of the bottle cap cover of the present invention;

FIG. 3 is a sectional view of the bottle cap cover of FIG. 1 taken along lines A-A;

FIG. 4 is a perspective view of the bottle cap cover of the present invention attached to a bottle cap which in turn is threaded onto a bottle;

FIG. 5 is a bottom perspective view of the bottle cap cover of the present invention having a bottle cap frictionally mounted therein; and

FIG. 6 is a front elevational view of a set of the subject bottle cap covers of the present invention each having different surface ornamentation to distinguish one corresponding bottle from another.

### DETAILED DESCRIPTION OF THE PREFERRED EMBODIMENT

It should be clearly understood at the outset that like reference numerals are intended to identify the same structural elements, portions or surfaces consistently throughout the several drawings herein, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, any reference to the terms “horizontal”, “vertical”, “left”, “right”, “up”, “down”, “inward”, and “outward” and the like as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

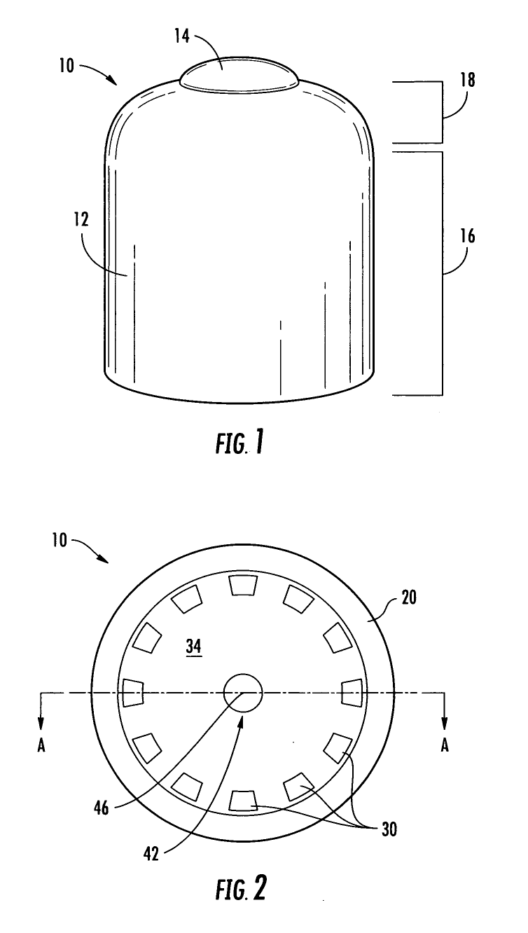

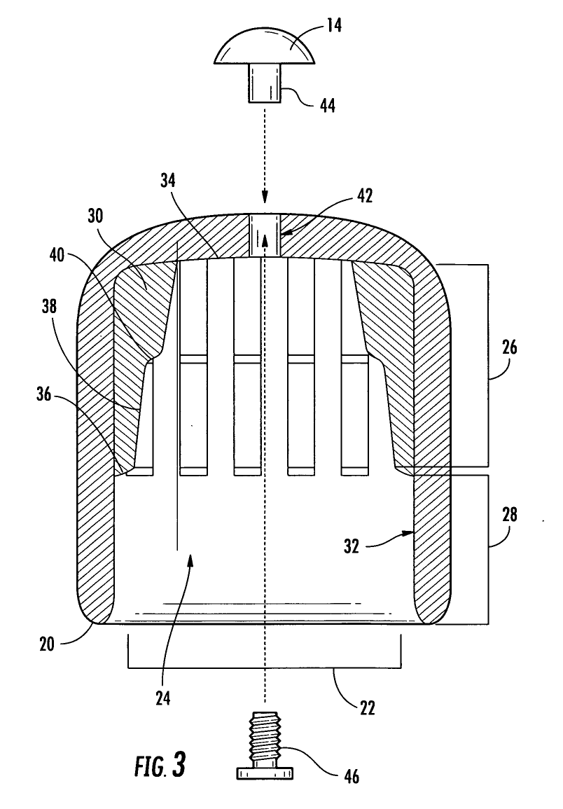

Reference is first made to FIG. 1 in which there is illustrated a front elevational view of the bottle cap cover and removal apparatus of the present invention designated generally by reference numeral 10. The apparatus is comprised of two primary components, namely a hollowed body 12, and optional 3-dimensional personalization means 14 integrally formed with or mounted to the top of hollowed body 12. Body 12 is comprised of a material deformable under hand pressure, but which returns to its original shape when pressure is released. Body 12, therefore, is subject to elastic deformation, a deformation which is reversible. Soft thermoplastics have moderate elastic deformation ranges and are therefore preferred. Thermoplastics are desirable because of their light weight relative to other deformable materials such as metals, and because of their considerable longevity in terms of extension/flexion cycles and because they can be impregnated with antimicrobials. Body 12 of the subject invention may be fabricated to varying dimensions to afford different degrees of deformation. In one example, body 12 is made of a molded rubber or silicon product, but may be made of any material having suitable resiliency and malleability for purposes herein described. The exterior of body 12 is preferably circular in cross section (FIG. 2) and has a first portion comprised of preferably either cylindrical or slightly tapered (wider at bottom) wall 16 and a second portion comprised of dome-shaped top 18.

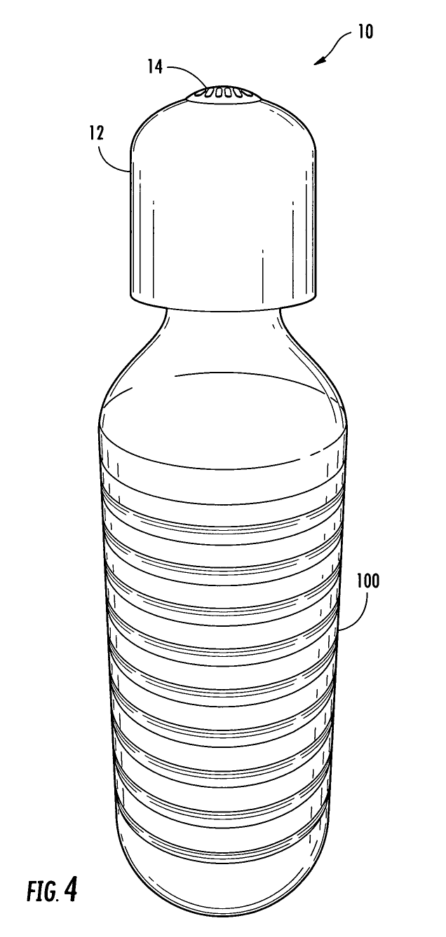

Reference being made to FIGS. 2 and 3, the bottom edge 20 of body 12 forms an opening 22 for access to chamber 24 which will receive a bottle cap 102. Bottom edge 20 is ring shaped which allows the subject apparatus 10 to stand on its own, providing for easy storage or display.

Chamber 24 is comprised of cap engaging portion 26 and skirt portion 28. Cap receiving portion 26 is defined by that portion of chamber 24 that includes a plurality of incrementally spaced cap engaging members 30 extending radially from the interior surface 32 of body 12 a distance into chamber 24 (FIG. 2). As best observed upon reference to FIG. 3, each cap engaging member 30 is attached at a first end to ceiling 34 of dome-shaped top 18 and extends in tapered fashion downwardly along interior surface 32 of wall 16 until terminating at first shoulder 36 a distance above bottom edge 20. Each cap engaging member 30, therefore, is wider at the top than at the bottom, each having a tapered edge 38 when viewed in profile. Conversely, cap engaging members 30 together create a cap engaging portion 26 of chamber 24 that is wider at its bottom (substantially equal to the diameter of opening 22) and tapers inwardly, narrowing in the direction of ceiling 34. Thusly shaped, cap receiving portion 26 of chamber 24 is better able to accommodate caps 102 (not shown) of different diameters. Each cap engaging member 30 may be further modified with a second shoulder 40 intermediate ceiling 34 and first shoulder 36. The distance between first shoulder 36 and second shoulder 40 may, for instance be substantially equal to the height of a standard bottle cap such that its top edge comes into abutting engagement with second shoulder 40 when mounted within the subject apparatus. Caps with smaller diameters can be mounted in that portion of chamber 34 above second shoulder 40.

As mentioned above, it is an important feature of the subject invention that its body be constructed of materials that are resilient and malleable. This characteristic aids in conforming the apparatus around a bottle cap by permitting a degree of temporary deformation of body 12 in the form of stretching and bending as cap engaging members 30 are caused to come into frictional engagement with the ribbed surface of a cap 102 in a snug fitting fashion. The frictional grip between interior surface 32 and bottle cap 102 keeps cap cover 10 firmly in place, but also allows for easy separation and preservation of both bottle cap 102 and cap cover 10, making both reusable.

Once a cap 102 is removed, the apparatus will resume its original shape if any stretching of body 12 was required to accomplish mounting of the apparatus. Moreover, the resilient and malleable nature of body 12 facilitates a better hand grip on the apparatus thereby providing greater leverage for accomplishing the removal of a cap from its bottle. Gripping this material is also easier on the hands and fingers than is gripping the smaller and rigid bottle cap itself. Similarly, the larger surface area of the subject bottle cap cover 10 as compared with a bottle cap 102 makes the former easier to hold and turn than the latter.

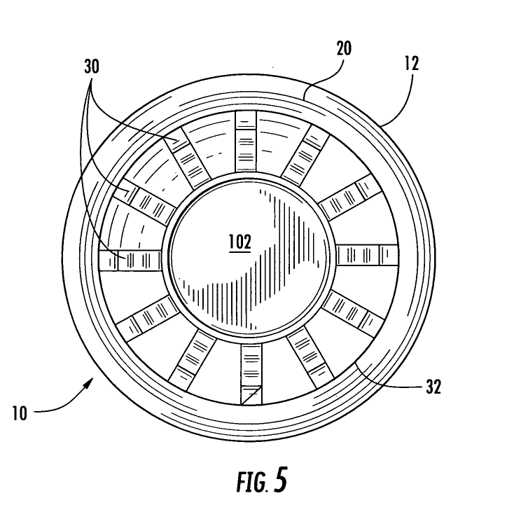

FIG. 4 depicts a bottle cap cover 10 of the subject invention removably mounted to a bottle cap which in turn is threaded onto a beverage bottle 100.

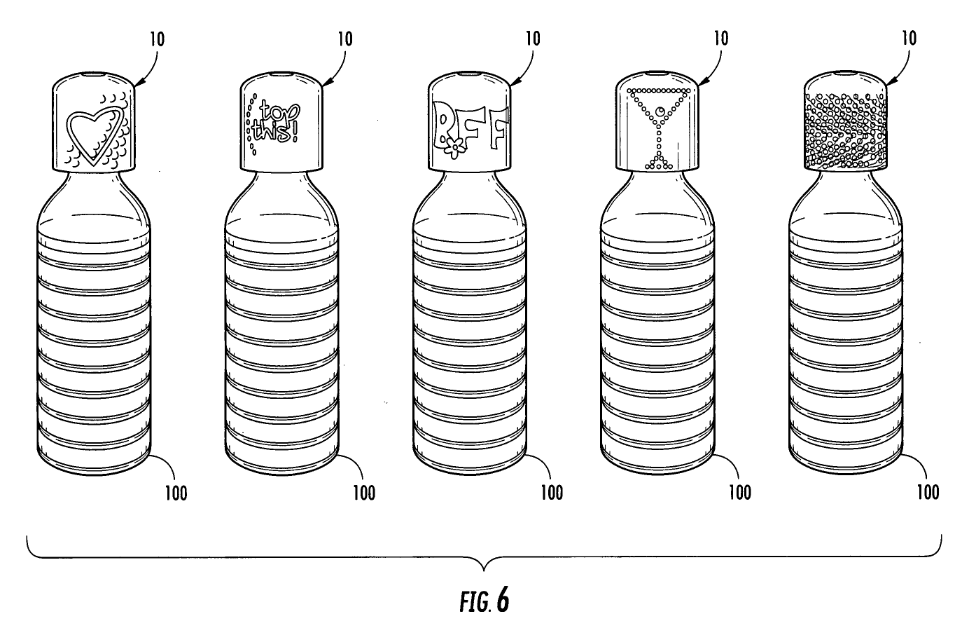

With reference being made to FIG. 5, note that skirt portion 28 of body 12 is not necessarily intended to receive a bottle cap 102 against its inner surface. Rather, the purpose of skirt portion 28 is to increase the exterior surface area of body 12 thereby increasing the amount of surface ornamentation that may be displayed upon it (as well as providing a greater gripping area to facilitate cap removal). Creating a uniform and relatively large surface area is an important feature of the subject apparatus. Specifically, body 12 may be customized to distinguish it from others of its kind. For example, body 12 may include surface ornamentation in the form of color, graphics, logos, textures, text or other visually distinctive indicia such as an organization's promotional or advertising indicia. With reference being made to FIG. 6 it may be observed that a plurality of the subject bottle cap covers may be sold as a set, with each individual bottle cap cover having its own unique surface ornamentation. An infinite number of different visual effects are possible.

In another embodiment of the invention, 3-dimensional personalization means 14 may be either integrally formed with or mounted to the top of hollowed body 12. With reference once again being made to FIGS. 1-3, 3-dimensional personalization means may be any decorative object that size and weight allow to be attached to body 12. For example, 3-dimensional personalization means 14 may be a figurine or other 3-D work of visual art molded, sculpted or otherwise fabricated into any sturdy shape within size and weight constraints and can also be ornamented with colors, graphics, logos, textures, or text. In the embodiment illustrated, 3-dimensional personalization means 14 is in the form of a simple metallic button which may bear any one or combination of the aforesaid ornamental indicia. In a preferred embodiment, dome-shaped top 18 includes an aperture 42 through which a mounting stem 44 affixed to 3-dimensional personalization means 14 may be inserted for mounting purposes. 3-dimensional personalization means 14 may be secured to body 12 using appropriate mounting means which in the example illustrated is a screw 46 reciprocally threaded with the interior of hollowed stem 44. Glow in the dark for nightstand visibility.

It should now be readily understood and appreciated that subject bottle cap cover 10 when mounted to a bottle cap 102 of conventional beverage bottle 100 not only serves as a means of facilitating the screwing and unscrewing of the cap from the bottle, but further personalizes the bottle so as to avoid the unintended consumption of its contents by another, and still further serves as an advertising and promotional vehicle of either two-dimensional or 3-dimensional form, or both. Personal identification of beverage bottles reduces waste because no bottle will go unclaimed due to an individual's reluctance to drink from the wrong bottle and sanitary benefits will be experienced because mistaken identification of one's bottle will occur less often. Logos, text, graphics, mascot miniatures, and the like can be represented on the beverage container without disturbing the manufacturer's seal and provide an advertisement that can be reused by the consumer.

In a final embodiment of the subject invention, either body 12 or 3-dimensional personalization means 14, or both, may be constructed from or coated with a luminescent material so that the accompanying beverage bottle to which the apparatus is mounted may be found in the dark. A glow-in-the-dark bottle cap cover 10 could have utility when placing the bottle on a nightstand while sleeping, for example.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims ultimately appended hereto.

What is claimed as being new, useful and desired to be protected by Letters Patent of the United States is as follows:

1. A cover and removal apparatus for bottle caps of the plastic threaded variety, the apparatus being comprised of an elastically deformable hollowed body having a closed top, an open bottom and a cylindrical side wall therebetween; said top, bottom and side wall defining a chamber; said chamber having a cap engaging portion proximate said top and a skirt portion below said cap engaging portion; said cap engaging portion being sized and shaped to receive the bottle cap therein; said cap engaging portion including a plurality of incrementally spaced cap engaging members extending radially from said side wall into said chamber and longitudinally from said top a distance down said side wall in tapered fashion for frictional engagement with the bottle cap; whereby said hollowed body has a smooth exterior surface for receipt of promotional or other visually distinctive personalizing indicia thereon.

2. The bottle cap cover and removal apparatus of claim 1 further including three-dimensional personalization means integrally formed with or mounted to said top of said hollowed body.

3. The bottle cap cover and removal apparatus of claim 1 wherein said top is dome shaped.

4. The bottle cap cover and removal apparatus of claim 1 wherein said hollow body is resilient and malleable.

5. The bottle cap cover and removal apparatus of claim 1 wherein said hollow body is molded from rubber or silicon.

6. The bottle cap cover and removal apparatus of claim 3 further including three-dimensional personalization means integrally formed with or mounted to said top of said hollowed body.

7. The bottle cap cover and removal apparatus of claim 4 further including three-dimensional personalization means integrally formed with or mounted to said top of said hollowed body.

8. The bottle cap cover and removal apparatus of claim 5 further including three-dimensional personalization means integrally formed with or mounted to said top of said hollowed body.

9. The bottle cap cover and removal apparatus of claim 2 wherein said top is dome shaped.

10. The bottle cap cover and removal apparatus of claim 4 wherein said top is dome shaped.

11. The bottle cap cover and removal apparatus of claim 5 wherein said top is dome shaped.

12. The bottle cap cover and removal apparatus of claim 1 wherein said hollow body is resilient and malleable.

13. The bottle cap cover and removal apparatus of claim 2 wherein said hollow body is resilient and malleable.

14. The bottle cap cover and removal apparatus of claim 3 wherein said hollow body is resilient and malleable.

15. The bottle cap cover and removal apparatus of claim 5 wherein said hollow body is resilient and malleable.

16. The bottle cap cover and removal apparatus of claim 1 wherein said hollow body is molded from rubber or silicon.

17. The bottle cap cover and removal apparatus of claim 2 wherein said hollow body is molded from rubber or silicon.

18. The bottle cap cover and removal apparatus of claim 3 wherein said hollow body is molded from rubber or silicon.

19. The bottle cap cover and removal apparatus of claim 4 wherein said hollow body is molded from rubber or silicon.

20. The bottle cap cover and removal apparatus of claim 2 wherein at least one of said hollow body and said three-dimensional personalization means is luminescent.
